(19) United States
(12) Patent Application Publication
(10) Pub. No.: US 2013/0094518 A1
(43) Pub. Date: Apr. 18, 2013

(54) METHOD FOR CONFIGURING AND TRANSMITTING MMT PAYLOAD

(71) Applicant: Electronics and Telecommunications Research, Daejeon (KR)

(72) Inventor: Seong Jun BAE, Daejeon-si (KR)

(73) Assignee: Electronics and Telecommunications Research Institute, Daejeon (KR)

(21) Appl. No.: 13/650,949

(22) Filed: Oct. 12, 2012

(30) Foreign Application Priority Data
Oct. 13, 2011 (KR) 10-2011-0104857
Dec. 1, 2011 (KR) 10-2011-0127997
Oct. 12, 2012 (KR) 10-2012-0113532

(51) Int. Cl. H04L 29/06

(52) U.S. Cl. CPC H04L 65/607
USPC 370/474

(57) ABSTRACT

A method for configuring and transmitting an MMT payload in a system are provided.. The method for configuring an MMT (MPEG Media Transport) payload format comprises configuring the MMT payload format such that essential information contained in each MMT payload format is included in a D-layer header, configuring the MMT payload format such that an MMT transmission packet includes one MMT payload format unit and configuring the MMT payload format such that packet streams are multiplexed in units of packets on a single port.

Priority to Korean patent application number 1 0-201 1-01 04857 filed on Oct. 13, 2011, 1 0-201 1-01 27997 filed on Dec. 1, 2011 and 10-2012-0113532 filed on Oct. 12, 2012, the entire disclosure of which is incorporated by reference herein, is claimed.

### BACKGROUND OF THE INVENTION

1. Field of the Invention

The present invention relates to an MMT (MPEG Media Transport) payload, and more particularly, to a method for configuring and transmitting an MMT payload format.

2. Discussion of the Related Art

Recently, ISO/IEC JTC1/SC29/WG11 (referred to as ‘MPEG’ hereinafter) is standardizing MPEG-H, a multimedia coding representation and multiplex transfer standard to be used in an UHDTV (Ultra-High-Definition TV) era in the future. Similar to the existing system such as MPEG-1, MPEG-2, MPEG-4, and the like, MPEG-H is comprised of systems such as Part 1 system, Part 2 video, and Part 3 audio, and the like, and due to be published as a set of standards. Part 1 of MPEG-H is MMT(MPEG Media Transport), Part 2 is HEVC(High-Efficiency Video Coding), and Part 3 is not decided yet but anticipated to be a next-generation audio compression coding standard, and the like, to be standardized for UHDTV in an MPDG audio subgroup after USAC (Universal Speech and Audio Coding). The MMT is a next-generation multimedia multiplexing transfer standard under standardization in MPEG, as a follow-up of MPEG-2 TS (Transport Stream), and HEVC is a next-generation video compression coding standard in consideration of its application to UHDTV under standardization by ISO and ITU-T in cooperation.

The MT is IP-friendly and aims at transferring multimedia using various types of channels. The MMT is comprised of an encapsulation (E) function, a delivery (D) function, and a control (C) function. Multimedia contents is packed as a single entity through the E function, the packed contents is packetized according to an IP protocol through the D function, and various types of control information including multimedia service search information is transferred through the C function.

At present in South Korea, many companies and schools are participating in MMT standardization, and techniques are being proposed for all areas of MMT. Especially, a method for configuring and transmitting/receiving an MMT payload is required.

### SUMMARY OF THE INVENTION

The present invention provides a method and apparatus for configuring an MMT payload having a novel structure.

The present invention also provides a method and apparatus for transmitting an MMT payload having a novel structure.

In an aspect, a method for configuring an MMT (MPEG Media Transport) payload format, comprises configuring the MMT payload format such that essential information contained in each MMT payload format is included in a D-layer header; configuring the MMT payload format such that an MMT transmission packet includes one MMT payload format unit; and configuring the MMT payload format such that packet streams are multiplexed in units of packets on a single port.

In another aspect, a method for transmitting an MMT payload format, comprises configuring the MMT payload format such that essential information contained in each MMT payload is included in a D-layer header, one MMT transmission packet includes one MMT payload format unit, and packet streams are multiplexed in units of packets on a single port; and transmitting the configured MMT payload.

According to the present invention, it is possible to provide an in-band signaling mechanism through an MMT delivery layer structure for delivering an MMT payload.

### BRIEF DESCRIPTION OF THE DRAWINGS

FIG. 1 is a view showing an example of MMT packetization according to the present invention.

### DETAILED DESCRIPTION OF THE PREFERRED EMBODIMENTS

Hereinafter, embodiments will be described in detail with reference to the accompanying drawings such that they can be easily practiced by those skilled in the art to which the present invention pertains. However, the present invention may be implemented in various forms and not limited to the embodiments disclosed hereinafter. Also, in order to clarify the present invention, parts irrespective of description will be omitted, and similar reference numerals are used for the similar parts throughout the specification.

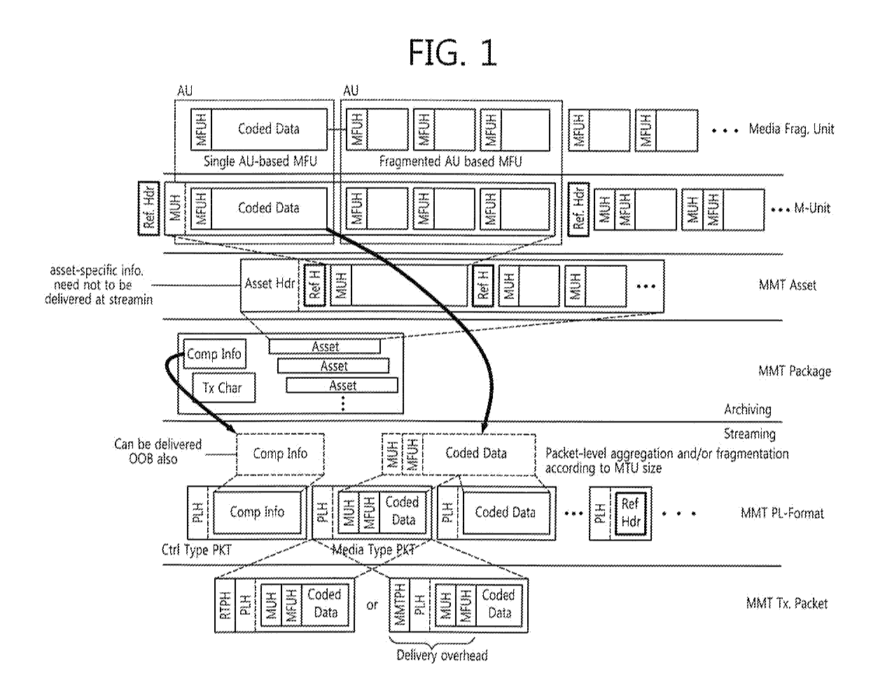

FIG. 1 is a view showing an example of MMT packetization according to the present invention. In this figure, MFUH denotes an MFU (MMT Format Unit) header, MUH denotes an M_unit header, PLH denotes an MMT payload format header, and MMTPH denotes an MMT transmission packet header.

An MMT payload format is a layer that performs the process required to transmit MMT-aware data through an IP (Internet Protocol) network.

An MMT transmission packet is an application layer for transmitting the MMT payload format through a transport protocol for the IP network. That is, the MMT payload format and the MMT transmission packet are two D-layers (delivery layers) in charge of packet-based delivery over the IP network.

Referring to FIG. 1, a media fragment unit is composed at least one single AU-based MFU (Single Access Unit-based MFU) or at least one fragmented MFU (Fragmented AU-based MFU). The single AU-based MFU includes an MFUH and coded data, and may constitute a single AU. A plurality of (three in FIG. 1) fragmented AU-based MFU may be combined into a single AU.

An M-unit may be composed of at least one single AU-based MFU (Single Access Unit-based MFU) or at least one fragmented AU-based MFU (Fragmented AU-based MFU), and may include a reference header (Ref Hdr) or an MUH.

An MMT Asset may include an Asset header (Asset Hdr), a reference header, and an MUH. Asset-specific information needs not to be delivered through the Asset header in streaming.

An MMT packet includes a comp. Info, a Tx. Char, and at least one MMT Asset.

An MMT PL-format may include a Control Type PKT containing comp. Info and a PLH or a Media Type PKT containing an AU and a PLH.

Packet-level aggregation and/or fragmentation are implemented according to MTU size.

The MMT transmission packet may be composed of an RTPH, a PLH, and an AU, or composed of an MMTPH, a PLH, and an AU. In the MMT transmission packet composed of an MMTPH, a PLH, and an AU, the MMTPH, the PLH, the MUH, and the MFUH may be combined and referred to as a delivery overhead.

In an example according to the present invention, the MMT payload format and the MMT transmission packet may be configured such that only essential information is included in the D-layer headers. Overhead can be minimized.

In another example according to the present invention, one MMT transmission packet may be configured to include only one MMT payload format unit. By this, payload unit aggregation or fragmentation according to MTU (Maximum Transfer Unit) size of the IP network occurs only in the step of configuring an MMT payload format unit.

In still another example according to the present invention, the MMT payload format and the MMT transmission packet may be configured such that packet streams with different characteristics are multiplexed in units of packets on a single port.

In a further example according to the present invention, the MMT payload format and the MMT transmission packet may be configured to provide a mechanism for in-band signaling.

In a further example, the MMT payload format and the MMT transmission packet may support an in-band signaling channel for each multiplexed substream, and may also support an in-band signaling channel for the entire multiplexed stream.

Now, the syntax and semantics of the MMT payload format according to the present invention will be described.

The MMT payload format is capable of aggregating or fragmenting a transmission unit according to MTU (Maximum Transfer Unit) size, which is limited in the IP network. The MMT payload format unit may have a fixed-size header, and may be in one or more of the group consisting of the aggregation mode, the single mode, and the fragmentation mode depending on how the values of flag_multiple_unit, flag_unit_start, and flag_unit_end are combined.

The following Table 1 shows an example of the MMT payload format. The present invention is not limited by the order of the components of the following Table 1. The components are not meant to be exclusive, and other components may be included or one or more components may be omitted.

TABLE 1

| | No. of | |
|---|---|---|
| Syntax | bits | Mnemonic |
| mmt_payload_format( ){ | | |
| flag_control | 1 | bslbf |
| flag_unit_start | 1 | bslbf |
| flag_unit_end | 1 | bslbf |
| flag_RAP | 1 | bslbf |
| flag_multiple_unit | 1 | bslbf |
| reserved | 3 | bslbf |
| | 16 | uimsbf |
| if(flag_multiple_unit == ‘1’){ | | |
| multiple_unit_payload( ) | | |
| } | | |
| else if(flag_multiple_unit == ‘0’){ | | |
| if(flag_unit_start == ‘1’ && flag_unit_end ==‘1’){ | | |
| single_unit_payload( ) | | |
| } | | |
| else if(flag_unit_start == ‘1’ && flag_unit_end ==‘0’){ | | |
| fragmented_unit_payload_first ( ) | | |
| } | | |
| else if(flag_unit_start == ‘0’ && flag_unit_end ==‘0’){ | | |
| fragmented_unit_payload_middle ( ) | | |
| } | | |
| else if(flag_unit_start == ‘0’ && flag_unit_end ==‘1’){ | | |
| fragmented_unit_payload_final ( ) | | |
| } | | |
| } | | |
| } | | |

In this table, flag_control indicates whether the MMT payload format is control information or not. In an example, if flag_control has the value 1, it indicates that the MMT payload format is control information, and if flag_control has the value 0, it indicates that the MMT payload format is not control information. For a media-type substream, an MMT payload format (i.e., control-type payload) having the same substream ID as the media-type substream, whose flag_control has the value 1, may be used as an in-band signaling channel for the media-type substream. However, the in-band signaling channel coupled to a specific media-type substream does not necessarily need to have the same substream ID as this media-type substream. In this case, the relationship between the specific media-type substream and the substream ID of the in-band signaling channel supporting this substream should be indicated in a different way.

If flag_unit_start has the value 1, it indicates that the MMT payload format contains the start portion of a packetization unit.

If flag_unit_end has the value 1, it indicates that the MMT payload format contains the end portion of the packetization unit.

If flag_RAP has the value 1, it indicates that the MMT payload format is a random access point.

If flag_multiple_unit has the value 1, it indicates that the MMT payload format includes two or more multiple formats.

Substream_seqno is a sequence number which is incremented by 1 for each of the packets of a packet stream having the same substream ID. Using substream_seqno, a packet sequence number-based operation, such as error checking and error recovery, may be applied in units of substreams.

Media data of various sizes is packetized according to MTU size for transmission over the IP network. In the MMT payload format, therefore, the aggregation mode, the single mode, and the fragmentation mode are provided, and the formats for these modes are as shown in the following Tables 2 through 4. The present invention is not limited by the order of the components of the following Tables 2 through 4. The components are not meant to be exclusive, and other components may be included or one or more components may be omitted.

TABLE 2

| Syntax | No. of bits | Mnemonic |
|---|---|---|
| single_unit_payload ( ){ | 16 | uimsbf |
| unit ( ) | | |
| } | | |

TABLE 3

| Syntax | No. of bits | Mnemonic |
|---|---|---|
| multiple_unit_payload ( ){ | 16 | uimsbf |
| for(i=0;i<N;i++){ | | |
| unit_size | | |
| unit ( ) | | |
| } | | |

TABLE 4

| Syntax | No. of bits | Mnemonic |
|---|---|---|
| unit( ){ | | |
| fragmented_unit_payload_first( ) | | |
| for(i=0;i<N;i++){ | | |
| fragmented_unit_payload_middle( ) | | |
| } | | |
| fragmented_unit_payload_final( ) | | |
| } | | |

Now, the syntax and semantics of the MMT transmission format according to the present invention will be described.

The MMT payload format is used as an RTP payload format over RTP, and at the same time used over the MMT transmission packet. An IP packet stream necessarily requires a sequence number of a string of packets for error checking, error recovery, etc, and the RTP packet includes a sequence number field for this string of packets. Accordingly, if the MMT payload format is used over RTP, the sequence number of RTP is used. Even when the MMT payload format is used over the MMT transmission packet, the MMT transmission packet has a general sequence number field for a packet stream to maintain consistency with the use of RTP.

The following Table 5 shows an example of the MMT transmission packet.

TABLE 5

| Syntax | No. of bits | Mnemonic |
|---|---|---|
| mmt_packet ( ){ | | |
| substream_id | 16 | uimsbf |
| sequence_no | 16 | uimsbf |
| mmt_payload_format ( ) | | |
| } | | |

In this table, sequence_no denotes the sequence number of a packet stream which is incremented by 1 for each packet.

Substream_id is an identifier for identifying individual streams having different characteristics when multiplexing these streams in a string of packets. Substream ID values may be allocated as shown in the following Table 6, or substream ID values may be dynamically allocated at the time of session initialization.

TABLE 6

| substream_id | Description |
|---|---|
| 0x0000 | Stream Control Information |
| 0x0001 ~ 0x00ff | Reserved |
| 0x0010 ~ 0xfffe | Allocated by User or System |
| 0xffff | Reserved |

As seen from above, the MMT Delivery Layer structure proposed according to the present invention provides two types of in-band signaling mechanisms: the first one provides an in-band signaling channel for the entire stream sharing a single port; and the second one provides an in-band signaling channel for each substream. In-band signaling for the entire stream may be provided through a preserved, specific substream ID (e.g., “substream_id=0”).

According to the present invention, method for configuring an MMT (MPEG Media Transport) payload format comprises configuring the MMT payload format such that essential information contained in each MMT payload format is included in a D-layer header; configuring the MMT payload format such that an MMT transmission packet includes one MMT payload format unit; and configuring the MMT payload format such that packet streams are multiplexed in units of packets on a single port.

The MMT payload format may provide an in-band signaling mechanism, and he MMT payload format and the multiplexed MMT transmission packet may be configured to support an in-band signaling channel for each substream.

The MMT payload format may be configured to further support an in-band signaling channel for each multiplexed stream.

The MMT payload format may be configured such that a control flag for indicating whether the MMT payload format contains control information is included in the MMT payload format.

The MMT payload format may be configured such that a unit start flag for indicating whether the MMT payload format contains the start portion of a packetization unit is included in the MMT payload format.

The MMT payload packet may be configured such that a unit end flag for indicating whether the MMT payload packet contains the end portion of the packetization unit is included in the MMT payload format.

The MMT payload format may be configured such that a random access point flag for indicating whether the MMT payload format is a random access point is included in the MMT payload format.

The MMT payload format may be configured such that a multiple unit flag for indicating whether the MMT payload format contains two or more multiple packets is included in the MMT payload format.

The MMT payload format may be configured to be used over an MMT transmission packet.

The MMT transmission packet may further comprise a substream ID which is an identifier for identifying streams having different characteristics in a string of packets when multiplexing these streams.

The MMT transmission packet may comprise a sequence number field of the packet string.

According to the present invention, a method for transmitting an MMT payload format comprises configuring the MMT payload format such that essential information contained in each MMT payload is included in a D-layer header, one MMT transmission packet includes one MMT payload format unit, and packet streams are multiplexed in units of packets on a single port; and transmitting the configured MMT payload.

The MMT payload format may provide an in-band signaling mechanism, and the MMT payload format and the multiplexed MMT transmission packet are configured to support an in-band signaling channel for each substream.

The MMT payload format may be configured to further support an in-band signaling channel for each multiplexed stream.

The MMT payload format may include a control flag for indicating whether the MMT payload format contains control information.

The MMT payload format may include a unit start flag for indicating whether the MMT payload format contains the start portion of a packetization unit.

The MMT payload packet may comprise a unit end flag for indicating whether the MMT payload packet contains the end portion of the packetization unit.

The MMT payload format may include a random access point flag for indicating whether the MMT payload format is a random access point.

The MMT payload format may include a multiple unit flag for indicating whether the MMT payload format contains two or more multiple packets.

In the exemplary system as described above, the methods are described based on the flow chart by sequential steps or blocks, but the present invention is not limited to the order of the steps, and a step may be performed in different order from another step as described above or simultaneously performed. It would be understood by a skilled person in the art that the steps are not exclusive, a different step may be included, or one or more of the steps of the flow chart may be deleted without affecting the scope of the present invention.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A method for configuring an MMT (MPEG Media Transport) payload format, the method comprising:
configuring the MMT payload format such that essential information contained in each MMT payload format is included in a D-layer header;
configuring the MMT payload format such that an MMT transmission packet includes one MMT payload format unit; and
configuring the MMT payload format such that packet streams are multiplexed in units of packets on a single port.

2. The method of claim 1, wherein the MMT payload format provides an in-band signaling mechanism, and
the MMT payload format and the multiplexed MMT transmission packet are configured to support an in-band signaling channel for each substream.

3. The method of claim 2, wherein the MMT payload format is configured to further support an in-band signaling channel for each multiplexed stream.

4. The method of claim 2, wherein the MMT payload format is configured such that a control flag for indicating whether the MMT payload format contains control information is included in the MMT payload format.

5. The method of claim 1, wherein the MMT payload format is configured such that a unit start flag for indicating whether the MMT payload format contains the start portion of a packetization unit is included in the MMT payload format.

6. The method of claim 1, wherein the MMT payload packet is configured such that a unit end flag for indicating whether the MMT payload packet contains the end portion of the packetization unit is included in the MMT payload format.

7. The method of claim 1, wherein the MMT payload format is configured such that a random access point flag for indicating whether the MMT payload format is a random access point is included in the MMT payload format.

8. The method of claim 1, wherein the MMT payload format is configured such that a multiple unit flag for indicating whether the MMT payload format contains two or more multiple packets is included in the MMT payload format.

9. The method of claim 1, wherein the MMT payload format is configured to be used over an MMT transmission packet.

10. The method of claim 9, wherein the MMT transmission packet further comprises a substream ID which is an identifier for identifying streams having different characteristics in a string of packets when multiplexing these streams.

11. The method of claim 9, wherein the MMT transmission packet comprises a sequence number field of the packet string.

12. A method for transmitting an MMT payload format, the method comprising:
configuring the MMT payload format such that essential information contained in each MMT payload is included in a D-layer header, one MMT transmission packet includes one MMT payload format unit, and packet streams are multiplexed in units of packets on a single port; and
transmitting the configured MMT payload.

13. The method of claim 12, wherein the MMT payload format provides an in-band signaling mechanism, and
the MMT payload format and the multiplexed MMT transmission packet are configured to support an in-band signaling channel for each substream.

14. The method of claim 13, wherein the MMT payload format is configured to further support an in-band signaling channel for each multiplexed stream.

15. The method of claim 12, wherein the MMT payload format includes a control flag for indicating whether the MMT payload format contains control information.

16. The method of claim 12, wherein the MMT payload format includes a unit start flag for indicating whether the MMT payload format contains the start portion of a packetization unit.

17. The method of claim 12, wherein the MMT payload packet comprises a unit end flag for indicating whether the MMT payload packet contains the end portion of the packetization unit.

18. The method of claim 12, wherein the MMT payload format includes a random access point flag for indicating whether the MMT payload format is a random access point.

19. The method of claim 12, wherein the MMT payload format includes a multiple unit flag for indicating whether the MMT payload format contains two or more multiple packets.
